(19) United States
(12) Patent Application Publication
(10) Pub. No.: US 2011/0095641 A1
(43) Pub. Date: Apr. 28, 2011

(54) DIELECTRIC EXTRUSION FOR STATOR SLOT LINERS

(75) Inventor: Frederick W. Rhoads, Holly, MI (US)

(73) Assignee: GM GLOBAL TECHNOLOGY OPERATIONS, INC., Detroit, MI (US)

(21) Appl. No.: 12/604,604

(22) Filed: Oct. 23, 2009

(51) Int. Cl. H02K 3/34; H02K 15/10

(52) U.S. Cl. 310/215; 29/596

(57) ABSTRACT

An electric motor includes a rotor and a stator assembly concentrically located about the rotor. The stator assembly includes a stator stack and a plurality of spaced apart stator teeth extending radially from the stator stack. The plurality of stator teeth define a plurality of stator slots. A plurality of slot liners are each inserted within a respective one of the stator slots. The slot liners are each formed from a length of extruded dielectric material. A method of manufacturing the electric motor includes inserting the extruded slot liners into the stator slots, then inserting a plurality of conductors into the respective one of the plurality of cavities that are defined by the extruded slot liner.

### TECHNICAL FIELD

The present invention relates, generally, to a stator for an electric motor, and more specifically, to a slot liner for a stator of the electric motor.

### BACKGROUND OF THE INVENTION

Electric motors include stator assemblies which have conductors for the motor. A stator stack for the stator assembly includes teeth that extend radially from the stator stack. The conductors are inserted into slots defined by the spaced apart stator teeth. Stator slot liners, or stator paper, are inserted within the stator slots to electrically isolate the conductors. The conductors must be electrically isolated from the stator stack to prevent phase to ground shorts and from one another to prevent phase to phase shorts from occurring.

Stator slot liner material is provided in sheets which are bent into the appropriate shape to electrically isolate the conductors. Typically, the slot liner materials are bent into S-shapes or B-shapes. Each sheet of slot liner material is heated and bent to the appropriate shape. After cooling, the sheets are cut to the proper length, folded into the appropriate shape, and inserted within the stator stack.

The number and cross-sectional shape of the conductors determines the shape the slot liner material is folded into to electrically isolate the conductors. Additionally, depending on the number of conductors assembled in each stator slot for a particular electric motor, more than one sheet of slot liner material may be required per slot to electrically isolate all the conductors.

### SUMMARY OF THE INVENTION

An electric motor includes a rotor and a stator assembly concentrically arranged about the rotor. The stator assembly includes a stator stack which includes a plurality of spaced apart stator teeth extending radially from the stator stack. The plurality of stator teeth define a plurality of stator slots. A plurality of slot liners are each inserted within a respective one of the stator slots. The slot liners are each formed from a length of extruded dielectric material.

A method of manufacturing the electric motor includes inserting an extruded slot liner into a stator slot for a stator. After the extruded slot liner is inserted in the stator slot, then a plurality of conductors are inserted into a respective one of a plurality of cavities that are defined by the extruded slot liner.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross-sectional view of a rotor and a stator assembly for an electric motor;

FIG. 2 is a partial schematic cross-sectional view of the rotor and the stator assembly, illustrating a first embodiment of a stator assembly showing a stator slot and a stator slot liner;

FIG. 3A is a partial schematic perspective view of the first embodiment of the stator slot liner of FIGS. 1 and 2;

FIG. 3B is a partial schematic end view of the first embodiment of the stator slot liner of FIGS. 1, 2 and 3A;

FIG. 4A is a partial schematic perspective view of a second embodiment of the stator slot liner of FIGS. 1 and 2; and

FIG. 4B is a partial schematic end view of the second embodiment of the stator slot liner of FIGS. 1, 2 and 4A.

### DESCRIPTION OF THE PREFERRED EMBODIMENTS

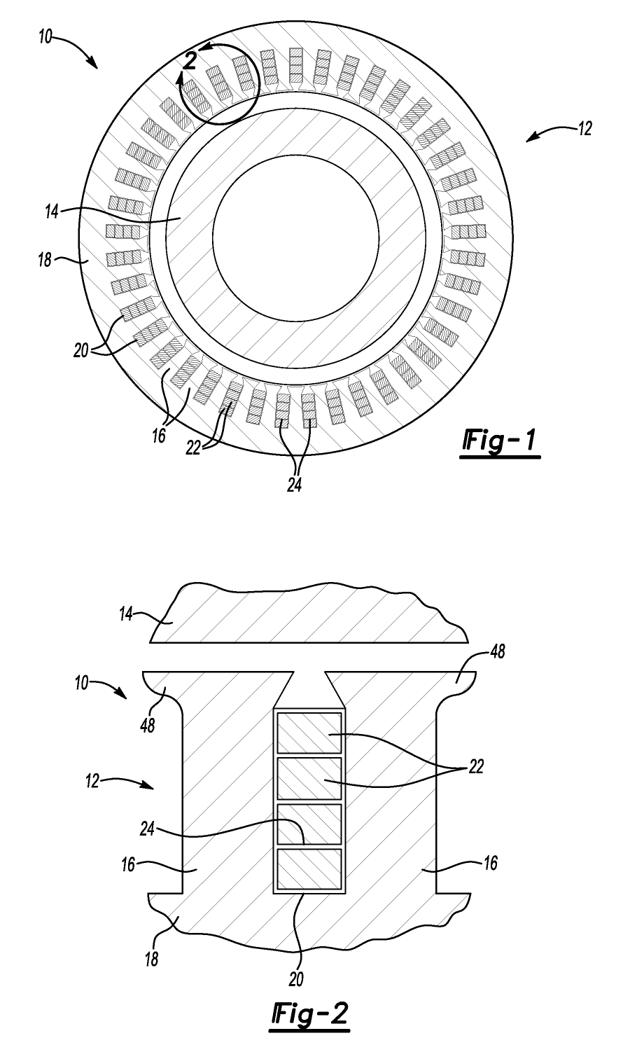

Referring to the Figures, wherein like reference numbers refer to the same or similar components throughout the several views, FIGS. 1 and 2 partially schematically illustrate an electric motor 10 having a stator assembly 12 and a rotor 14. The stator assembly 12 includes a plurality of stator teeth 16. The stator teeth 16 extend radially from a stator stack 18 and are spaced apart to form stator slots 20. A plurality of conductors 22 are inserted within the stator slots 20. A stator slot liner 24 is inserted within the stator slots 20 to electrically isolate the conductors 22 from the stator stack 18 and from one another. The conductors 22 must be electrically isolated from the stator stack 18 to prevent phase to ground shorts and the conductors 22 must be electrically isolated from one another to prevent phase to phase shorts from occurring.

In the embodiment shown, the stator slots 20 are open slots and the conductors 22 and the slot liner 24 may be axially or radially inserted. However, the stator slots 20 may also be closed slots 20 and the conductors 22 and the slot liner 24 may be radially inserted.

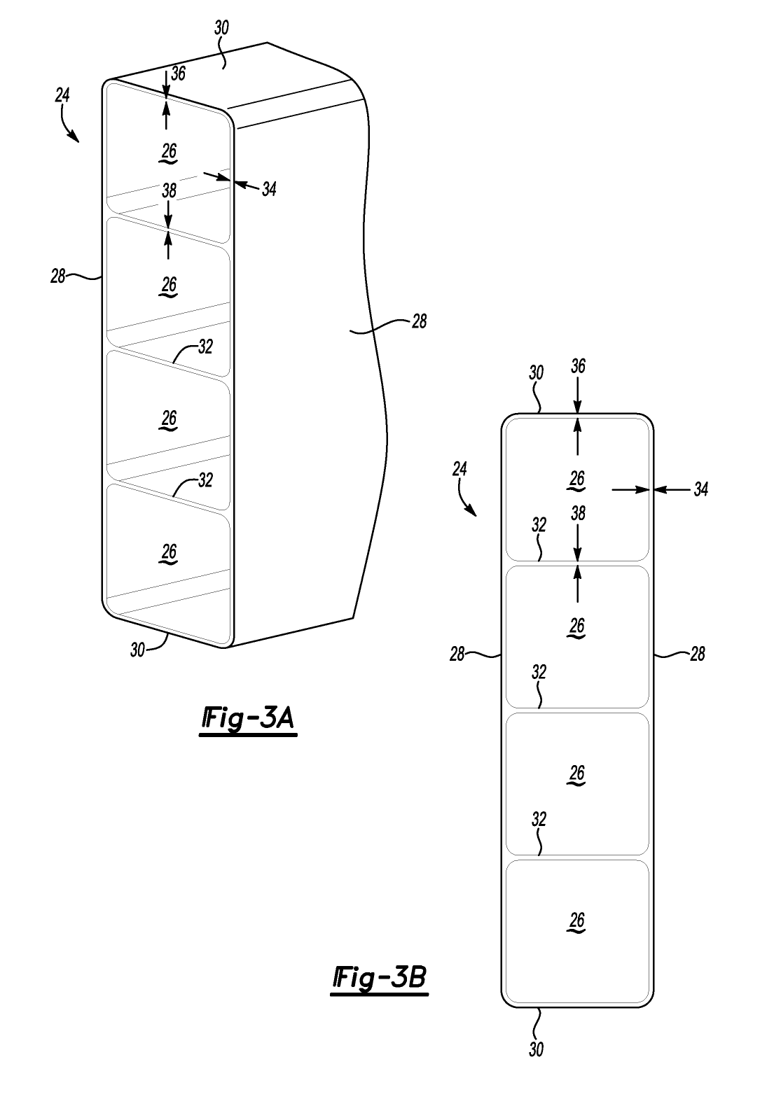

Referring to FIGS. 2, 3A and 3B, the slot liner 24 is explained in further detail. The slot liner 24 is extruded from a dielectric material to form a one-piece slot liner 24. The slot liner 24 may be formed from any material capable of being extruded which is also capable of electrically isolating the conductors 22.

The slot liner 24 is preferably a multi-lumen slot liner 24 that defines a plurality of cavities 26. The number and shape of the cavities 26 are determined by the number and shape of conductors 22 which are assembled within each slot 20. In the embodiment shown, there are four conductors 22 per slot and the conductors 22 are formed from wire having a square cross-sectional shape. The number and shape of the conductors 22, and thus cavities 26, may vary according to the design and purpose of the electric motor 10. One skilled in the art would be able to determine the appropriate number and shape of the conductors 22 and cavities 26 for a particular electric motor 10.

The slot liner 24 has a pair of opposing side walls 28, a pair of opposing end walls 30, and at least one dividing wall 32. The opposing side walls 28 have a first thickness 34, the opposing end walls 30 have a second thickness 36, and the dividing walls 32 have a third thickness 38. Because the slot liner 24 has been extruded as a single piece, the dividing walls 32 do not have double thickness, as sometimes occurs when bending sheets of material into the desired shapes. Additionally, the side walls 28, the end walls 30, and the dividing walls 32 enclose the cavities 26 around a portion of the length of the conductor 22. The conductor 22 ends, which extend axially from the stator stack 18, remain exposed as required for operation of the electric motor 10. Providing for enclosed cavities 26 ensures that there are no gaps in the isolating material, as sometimes occurs when bending sheets of material into the desired shapes.

It is desirable for electric motors 10 to have a high a power density. Power density refers to the ratio of power output to the size of the motor. Electric motors 10 are being more frequently used in applications where space is limited. Therefore, to maintain as small a size as possible it is desirable to reduce the package area required by the slot liner 24 and the conductors 22 thus reducing the required size for each stator slot 20 and the overall stator assembly 12. Therefore, it is desirable to provide the slot liner 24 with side walls 28, end walls 30, and dividing walls 32 having the smallest thickness possible while providing the level of electrical isolation required by the electric motor 10. Additionally, extruding the slot liner 24 into the desired shape eliminates the double wall thickness, as mentioned above, which also reduces the package area required by the slot liner 24 and the conductors 22.

In the embodiment shown, the first, second, and third thicknesses 34, 36, 38 are equal such that the side walls 28, end walls 30, and dividing walls 32 are of equal thickness. Alternatively, the first thickness 34, the second thickness 36, and/or the third thickness 38 may be different thicknesses to provide different amounts of electrical isolation as may be required by the electric motor 10. For example, end walls 30 may require less electrical isolation than the dividing walls 32 and therefore the second thickness 36 may be less than the third thickness 38. One skilled in the art would be able to determine the required thickness for each of the side walls 28, end walls 30, or dividing walls 32.

A typical method of assembly for the electric motor 10 includes inserting the slot liner 24 into the stator slot 20, then inserting the conductors 22 into the individual cavities 26 defined by the slot liner 24. The slot liner 24 may be pre-cut to the required length for a particular electric motor 10. Alternatively, the slot liner 24 may provided as a continuous roll and cut to length at the time of assembly within the stator slots 20. Providing a single piece pre-formed slot liner 24 for each stator slot 20 reduces the numbers of components and assembly time required for each electric motor 10.

During the insertion process, the conductors 22 may catch on folds or burrs that are located on conventional slot liners as a result of the manufacturing process. Therefore, assembly of the electric motor 10 is a time when the slot liner 24 is susceptible to tearing. Additionally, the electric motor 10 is exposed to many heat cycles over the life of the electric motor 10. The heat cycles may cause relative motion between the conductors 22, the slot liner 24, and the stator stack 18. As a result of the relative motion, the slot liner 24 is at risk of tearing at this time as well. Providing an extruded slot liner 24 reduces the number of burrs and folds in the material of the slot liner 24, making it less susceptible to tearing during insertion or due to relative motion between the slot liner 24 and the stator stack 18.

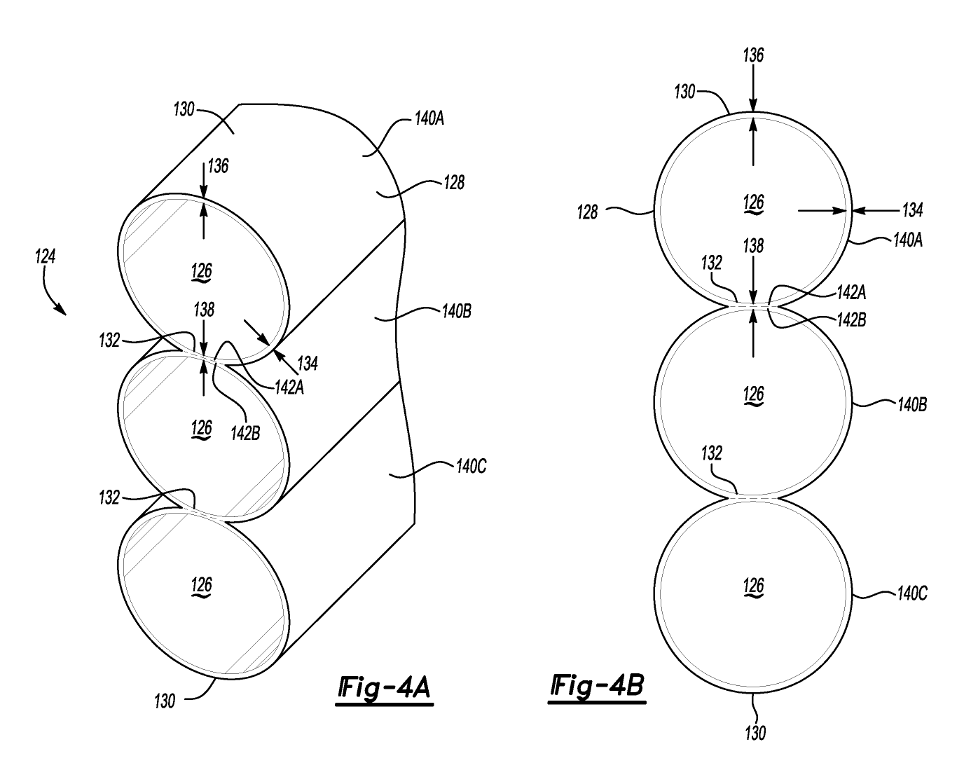

Referring to FIGS. 1, 4A and 4B a second embodiment of a slot liner 124 for use with an electric motor 10 is illustrated. The slot liner 124 defines a plurality of cavities 126. The number and shape of the cavities 126 are determined by the number and shape of conductors 22 (shown in FIG. 1) which are assembled within each slot 20 (shown in FIG. 1). In the embodiment shown in FIG. 4, the slot liner 124 has three cavities 125 for use with an electric motor 10 that uses three conductors 22 per stator slot 20 and the conductors 22 are formed from wire having a round cross-sectional shape. The number and shape of the conductors 22, and thus cavities 126, may vary according to the design and purpose of the electric motor 10. One skilled in the art would be able to determine the appropriate number and shape of the conductors 22 and cavities 126 for a particular electric motor 10.

In the second embodiment the slot liner 124 is extruded from a dielectric material to form a plurality of straws 140A-C (i.e. generally tubular shapes). The slot liner 124 may be formed from any material capable of being extruded which is also capable of electrically isolating the conductors 122. The straws 140A-C are individually extruded and each define one cavity 126. The straws 140A-C are then bonded together to form a single piece slot liner 124 assembly having multiple cavities 126. The numbers of straws 140A-C which are bonded together is determined by the number of conductors 22 which are assembled within each slot 20.

The slot liner 124 has a pair of opposing side wall portions 128, a pair of opposing end wall portions 130, and at least one dividing wall portion 132. The opposing side wall portions 128 have a first thickness 134, the opposing end wall portions 130 have a second thickness 136, and the dividing wall portions 132 have a third thickness 138. Because the slot liner 124 has been extruded as individual straws 140A-C each dividing wall portion 132 is formed having a first portion 142A from one straw 140A-C and a second portion 142B from a second straw 140A-C. The first portion 142A and the second portion 142B may each have a reduced thickness to maintain the overall third thickness 138 as evenly as possible with the first thickness 134 and the second thickness 136 when the straws 140A-C are bonded together. Alternatively, the third thickness 138 may be greater than the first thickness 134 and the second thickness 136, but less thick than the material that is double during the folding process used for a conventional stator slot liner.

The side wall portions 128, the end wall portions 130, and the dividing wall portions 132 enclose the cavities 126 around a portion of the length of the conductor 122. The conductor 122 ends which extend axially from the stator stack 18 remain exposed as required for operation of the electric motor 10. Providing for enclosed cavities 126 ensures that there are no gaps in the isolating material, as sometimes occurs when bending sheets of material into the desired shapes.

It is desirable for electric motors 10 to have a high a power density. Power density refers to the ratio of power output to the size of the motor. Electric motors 10 are being more frequently used in applications where space is limited. Therefore, to maintain as small a size as possible it is desirable to reduce the package area required by the slot liner 124 and the conductors 22. Therefore, it is desirable to provide the slot liner 124 with side wall portions 128, end wall portions 130, and dividing wall portions 132 having the smallest thickness possible while providing the level of electrical isolation required by the electric motor 10. Additionally, extruding the slot liner 124 into the desired shape eliminates the double wall thickness, as mentioned above, which also reduces the package area required by the slot liner 124 and the conductors 22.

The first thickness 134, the second thickness 136, and/or the third thickness 138 may be different thicknesses to provide different amounts of electrical isolation as may be required by the electric motor 10 and as a result of the bonding process. One skilled in the art would be able to determine the required thickness for each of the side wall portions 128, end wall portions 130, or dividing wall portions 132.

A typical method of assembly for the electric motor 10 includes inserting the slot liner 124 into the stator slot 20, then inserting the conductors 22 into the individual cavities 126 defined by the slot liner 124. Providing a pre-formed slot liner 124 assembly for each stator slot 20 reduces the numbers of pieces and assembly time required for each electric motor 10. The straws 140A-C are bonded together prior to the slot liner 124 being inserted within the electric motor 10. Therefore, at the time of assembly of the electric motor 10 only one single slot liner 124 assembly is inserted into each of the stators slots 20.

During the insertion process, the conductors 22 may catch on folds or burrs that are located on conventional slot liners as a result of the manufacturing process. Therefore, assembly of the electric motor 10 is a time when the slot liner 124 is susceptible to tearing. Additionally, the electric motor 10 is exposed to many heat cycles over the life of the electric motor 10. The heat cycles may cause relative motion between the conductors 22, the slot liner 124, and the stator stack 18. As a result of the relative motion, the slot liner 124 is at risk of tearing at this time as well. Providing an extruded slot liner 124 reduces the number of burrs and folds in the material of the slot liner 124, making it less susceptible to tearing during insertion or due to relative motion between the slot liner 124 and the stator stack 18.

While the best modes for carrying out the invention have been described in detail, those familiar with the art to which this invention relates will recognize various alternative designs and embodiments for practicing the invention within the scope of the appended claims.

1. An electric motor comprising:
a stator stack;
a plurality of spaced apart stator teeth extending radially from the stator stack, wherein the plurality of stator teeth define a plurality of stator slots;
a plurality of slot liners, wherein each of the plurality of slot liners defines a plurality of cavities, and wherein each of the plurality of stator slots contains one respective stator liner;
a plurality of conductors, each of the plurality of conductors being axially inserted within a respective one of the cavities; and
wherein each of the plurality of slot liners is formed from a length of extruded dielectric material.

2. The electric motor of claim 1, wherein each of the plurality of conductors has a portion of a length of the conductor entirely surrounded by a respective one of the plurality of slot liners.

3. The electric motor of claim 1, wherein the each of the plurality of slot liners is formed as a single extruded piece defining a plurality of cavities.

4. The electric motor of claim 1, wherein each of the plurality of slot liners further comprises a plurality of extruded straws bonded together, and wherein each of the plurality of straws defines a respective one of the plurality of cavities.

5. A stator assembly comprising:
a stator stack;
a plurality of spaced apart stator teeth extending radially from the stator stack, wherein the plurality of stator teeth define a plurality of stator slots;
a plurality of conductors axially inserted within the stator slots;
a plurality of single piece slot liners, wherein one slot liner is inserted within a respective one of the stator slots, and
wherein each of the plurality of slot liners is formed from a length of extruded dielectric material.

6. The stator assembly of claim 5, wherein each of the plurality of slot liners defines a plurality of cavities, and wherein each of the plurality of conductors are inserted within a respective one of the plurality of cavities.

7. The stator assembly of claim 6, wherein each of the plurality of conductors has a portion of a length of the conductor entirely surrounded by the respective one of the plurality of slot liners.

8. The stator assembly of claim 6, wherein the each of the plurality of slot liners is formed as a single extruded piece defining a plurality of cavities.

9. The stator assembly of claim 6, wherein each of the plurality of slot liners further comprises a plurality of extruded straws bonded together, and wherein each of the plurality of straws defines a cavity.

10. A method of manufacturing an electric motor comprising:
inserting an extruded slot liner into a stator slot for a stator, and
inserting a plurality of conductors into respective ones of a plurality of cavities that are defined by the extruded slot liner.

11. The method of claim 10, further comprising:
extruding a plurality of straws each defining one of the plurality of cavities; and
bonding the plurality of straws together to form the slot liner prior to inserting the slot liner within the stator slot.

12. The method of claim 10, further comprising:
extruding the slot liner as a single piece that defines the plurality of cavities prior to inserting the slot liner within the stator slot.

13. The method of claim 10, further comprising:
cutting the single piece slot liner to a pre-determined length prior to inserting the slot liner within the stator slot.

14. The method of claim 10, wherein inserting the plurality of conductors into the respective plurality of cavities further comprises inserting the plurality of conductors such that at least a portion of the length of each of the plurality of conductors is entirely surrounded by the slot liner.
